(19) United States
(12) Patent Application Publication
(10) Pub. No.: US 2011/0261182 A1
(43) Pub. Date: Oct. 27, 2011

(54) ELECTRONIC DEVICE AND METHOD FOR MONITORING A BABY SLEEPING

(75) Inventors: HOU-HSIEN LEE, Tu-Cheng (TW); CHANG-JUNG LEE, Tu-Cheng (TW); CHIH-PING LO, Tu-Cheng (TW)

(73) Assignee: HON HAI PRECISION INDUSTRY CO., LTD., Tu-Cheng (TW)

(21) Appl. No.: 12/854,183

(22) Filed: Aug. 11, 2010

(30) Foreign Application Priority Data
Apr. 21, 2010 (TW) 99112552

(51) Int. Cl. G08B 23/00; H04N 7/18

(52) U.S. Cl. 348/77; 340/573.1; 348/E07.085

(57) ABSTRACT

An electronic device and method for monitoring a baby sleeping includes presetting a warning message and designating a communication device to receive the warning message. A captured image of a baby is acquired and sent to the designated communication device. The electronic devices sends the warning message to the designated communication device if no face zone of the baby is detected from the captured image or if the baby is awake.

### BACKGROUND

1. Technical Field

Embodiments of the present disclosure relate to monitoring technology, and more particularly to an electronic device and a method for monitoring a baby sleeping.

2. Description of Related Art

Generally, a baby sleeps most of the time. People who look after a baby cannot stay with the baby all the time. For example, people have to do housework when the baby is asleep. However, people will worry about the baby while they are doing the housework. Thus, it is inconvenient for people to do other things when looking after the baby.

### BRIEF DESCRIPTION OF THE DRAWINGS

FIG. 1 is a schematic diagram of one embodiment of an electronic device in communication with a communication device.

FIG. 2 is a block diagram of one embodiment of the electronic device.

FIG. 3 is a schematic diagram of one embodiment of a crib having the electronic device of FIG. 2.

FIG. 4 is a flowchart of one embodiment of a method for setting data in the electronic device 1 of FIG. 2.

FIG. 5 is a flowchart of one embodiment of a method for monitoring baby sleep using the electronic device of FIG. 2.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module,” as used herein, refers to logic embodied in hardware or firmware, or to a collection of software instructions, written in a programming language, such as, Java, C, or Assembly, for example. One or more software instructions in the modules may be embedded in firmware, such as an erasable programmable read only memory (EPROM). It will be appreciated that modules may comprise connected logic units, such as gates and flip-flops, and may comprise programmable units, such as programmable gate arrays or processors. The modules described herein may be implemented as either software and/or hardware modules and may be stored in any type of computer-readable medium or other computer storage system.

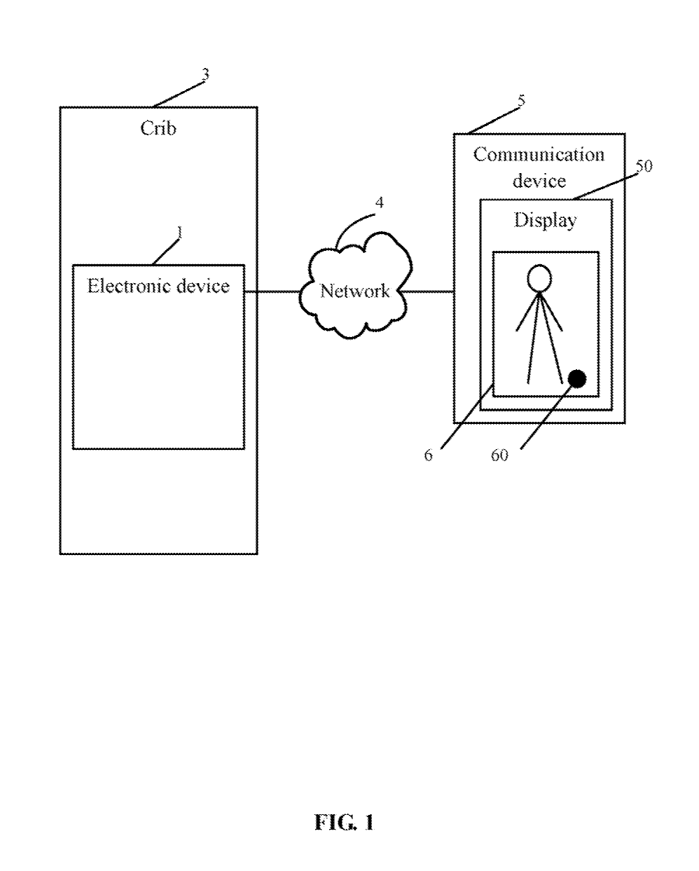

FIG. 1 is a schematic diagram of one embodiment of an electronic device 1 in communication with a communication device 5. The electronic device 1 may detect sleeping positions of a baby or determine if the baby is awake. Under the condition that an inappropriate sleeping position of the baby is detected or the baby is awake, the electronic device 1 may send a warning message to a designated communication device to warn people to come back to take care of the baby. Detailed descriptions are provided below.

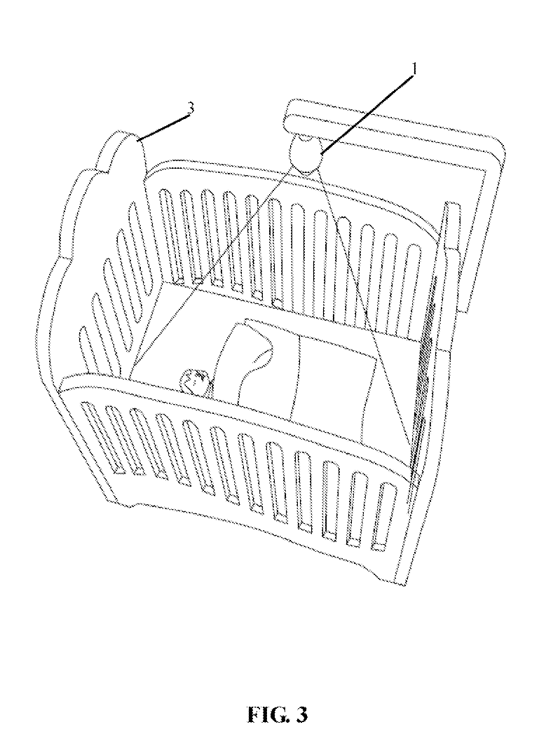

In some embodiments, the electronic device 1 may be positioned in an appropriate position of a crib 3 to capture images of the baby. As shown in FIG. 3, the electronic device 1 is positioned in a groove of a baffle or a valance of the crib 3. In some embodiments, the electronic device 1 may be a mobile phone, a personal digital assistant (PDA), or any other computing device.

The baby monitor is connected to the communication device 5 through a network 4. The communication device 5 may be a mobile phone, a PDA, or any other communication device. The communication device 5 includes a display 50. The display 50 may display the captured images received from the electronic device 1 through the network 4. The network 4 may be the Internet, BLUETOOTH, or the third generation (3G) network.

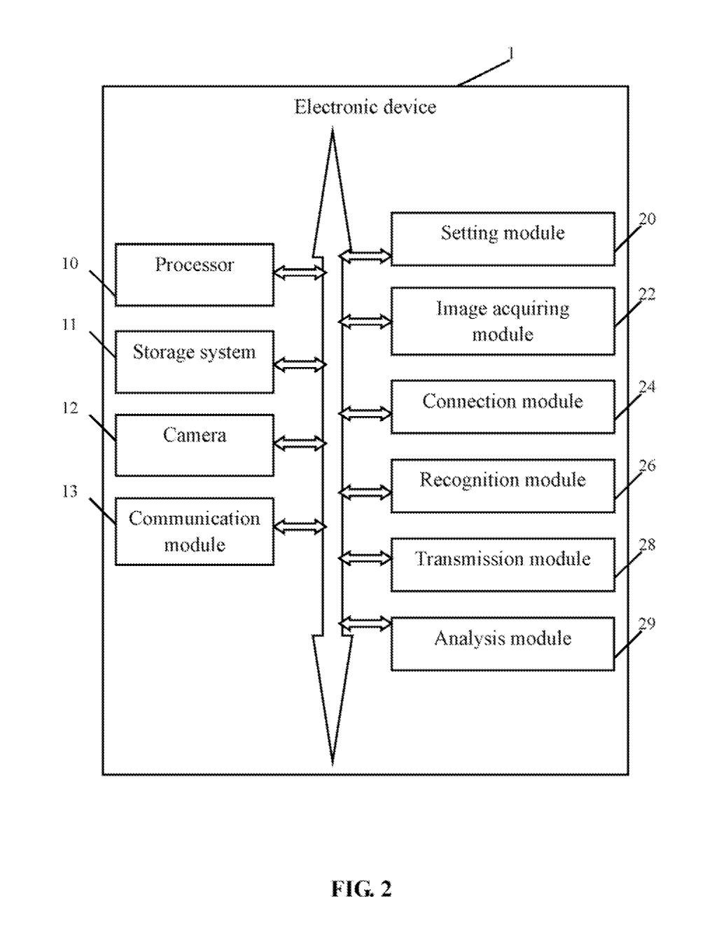

FIG. 2 is a block diagram of one embodiment of the electronic device 1. The electronic device 1 includes a processor 10, a storage system 11, a camera 12, and a communication module 13. The processor 10 executes one or more computerized operations of the electronic device 1 and other applications, to provide functions of the electronic device 1. The storage system 11 stores one or more programs, such as programs of the operating system, other applications of the electronic device 1, and various kinds of data, such as images, messages, for example. In one embodiment, the electronic device 1 may be a mobile phone, and the storage system 11 may include a memory of the electronic device 1 and/or an external storage card, such as a memory stick, a smart media card, a compact flash card, or any other type of memory card.

The camera 12 may capture images of a baby in the crib 3. The communication module 13 may help the electronic device 1 to communicate with the communication device 5. For example, the communication module 13 may be a global system for mobile communication (GSM) module.

In some embodiments, the electronic device 1 further includes a setting module 20, an image acquiring module 22, a connection module 24, a recognition module 26, a transmission module 28, and an analysis module 29. The modules 20, 22, 24, 26, 28 and 29 may include one or more computerized codes to be executed by the processor 10 to perform one or more operations of the electronic device 1. Details of these operations will be provided below.

The setting module 20 presets a warning message to warn a user to look at the baby in the crib 3, and designates a communication device of the user to receive the warning message. For example, the warning message may be “come back to look at your baby ASAP.” In some embodiments, the communication device 5 is designated as the designated communication device by inputting a phone number of the communication device 5 into the electronic device 1. The electronic device 1 may send the warning message to the communication device 5 according to the phone number of the communication device 5.

The setting module 20 further sets a threshold value of the electronic device 1 to determine if the baby is awake.

Under the condition that the electronic device 1 is powered on, the camera 12 starts to capture an image of the baby in the crib 3, and the connection module 24 establishes a communication between the electronic device 1 and the communication device 5 using the communication module 13 and the network 4.

The image acquiring module 22 acquires the captured image of the baby from the camera 12. The transmission module 28 sends the captured image of the baby to the communication device 5 through the communication.

The recognition module 26 detects a face zone of the baby from the captured image of the baby. In some embodiments, the face zone may be detected using a skin-color algorithm. The face zone is defined according to a range of skin colors of the baby's face. The range of the skin colors is disclosed as the following equation:

$${Skin}_{color} ( x , y ) = \{ \begin{matrix}1 , & if [ Cr ( x , y ) ∈ {Skin}_{Cr} ] ⋂ [ Cb ( x , y ) ∈ {Skin}_{Cb} ] \\ 0 , & otherwise \end{matrix}$$

If the value of Skin_{color} (x, y) is 1, the detected range of the face color is determined as the skin color. The recognition module 26 sets the color of the detected range as white. If the value of Skin_{color} (x, y) is not 1, the detected range of the face color is determined as being a non-skin color. The recognition module 26 sets the color of the detected range as black. After defining the face zone, the recognition module 26 defines a face-rectangular representation of a maximal of the face zone. The face-rectangular is a sampling space of characteristics within the face zone, which is defined by the recognition module 26 according to the characteristics within the face zone.

Under the condition that no face zone of the baby is detected from the captured image, the transmission module 28 sends the warning message to the communication device 5. For example, if a sleeping position of the baby has changed to be inappropriate, such as a face-down position, the face zone cannot be detected from the captured image of the baby. For another example, if a quilt covers the face of the baby, the face zone also cannot be detected from the captured image. It is not safe for the baby to be in an inappropriate sleeping position or to be covered by the quilt, thus, the user needs to go to look at the baby as soon as possible (ASAP). In response to receiving the warning message from the electronic device 1, the communication device 5 may output audio alarms, shake or blink continuously until the user gets the warning message.

Under the condition that the face zone of the baby is detected from the captured image, the recognition module 26 locates an eye area in the face zone. The recognition module 26 locates a rough eye area by detecting two circle shapes having a deeper color than a region from the detected face zone. After detecting the rough eye area, the recognition module 26 utilizes an algorithm, such as the Sobel algorithm, to enhance the border of the rough eye area and further blacken the rough eye area. The rough eye area is then processed by a binarization process to determine a clear eye area. The binarization process is an image binarizing algorithm based on a mathematical morphology.

After performing the binarization process, the recognition module 26 samples the border of the clear eye area to obtain an outline of the clear eye area using an algorithm, such as the Snake algorithm. The outline of the clear eye area is then utilized to define an eye-rectangular representative of a maximal of the clear eye area, and thus the recognition module 26 may obtain a height (H) and a width (W) of the eye-rectangular.

The analysis module 29 calculates a ratio (H/W) of the height (H) and the width (W) of the eye area, and determines if the baby is awake by comparing the calculated ratio with the threshold value. In some embodiments, if the calculated ratio is greater than the threshold value, the analysis module 29 determines that the baby is awake. If the calculated ratio is less than the threshold value, the analysis module 29 determines that the baby is asleep.

Under the condition that the baby is awake, the transmission module 28 sends the warning message to the communication device 5.

In another embodiments, the setting module 20 further sets a warning icon. For example, the warning icon may be a dot, an exclamatory mark, an icon or symbol. The transmission module 28 appends the warning icon on the captured image under the condition that no face zone of the baby is detected from the captured image or the baby is awake.

The transmission module 28 sends the captured image having the warning icon to the designated communication device. As shown in FIG. 1, the display 50 of the communication device 5 displays a captured image 6 having a warning icon 60 (e.g., a black dot).

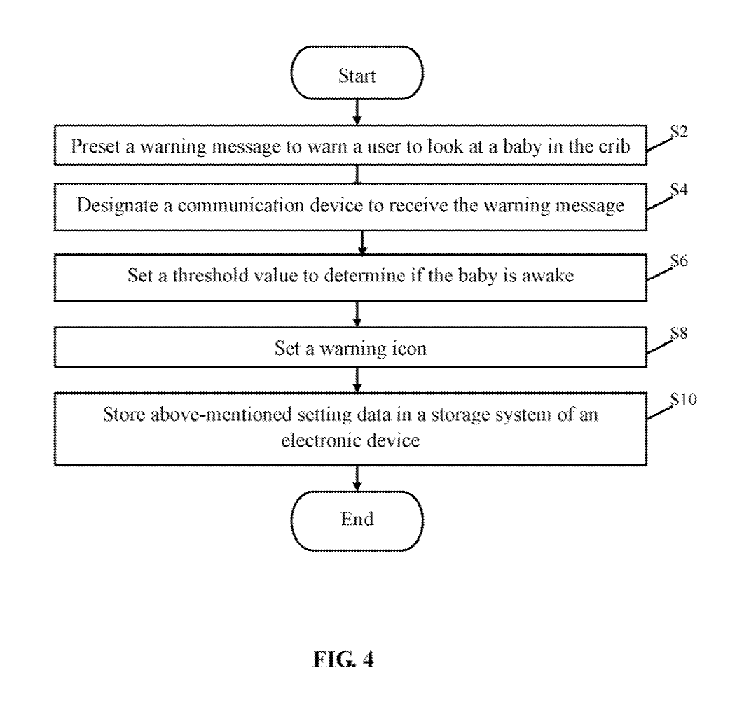

FIG. 4 is a flowchart of one embodiment of a method for setting data in the electronic device 1 of FIG. 2. Depending on the embodiment, additional blocks may be added, others removed, and the ordering of the blocks may be replaced.

In block S2, the setting module 20 presets a warning message to warn a user to look at the baby in the crib 3. As mentioned above, the warning message may be “come back to look at your baby ASAP.”

In block S4, the setting module 20 designates a communication device (e.g., the communication device 5) of the user to receive the warning message.

In block S6, the setting module 20 further sets a threshold value of the electronic device 1 to determine if the baby is awake.

In block S8, the setting module 20 further sets a warning icon, which can be appended on images.

In block S10, the setting module 20 stores above-mentioned setting data in the storage system 11 of the electronic device 1.

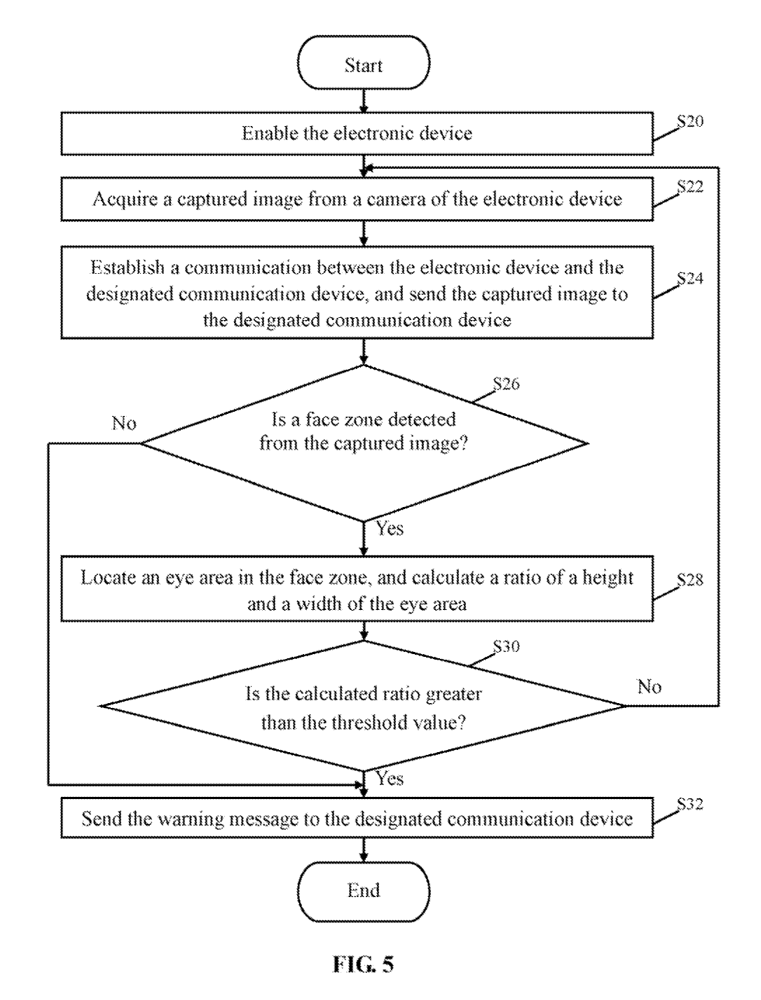

FIG. 5 is a flowchart of one embodiment of a method for monitoring a baby sleeping using the electronic device 1 of FIG. 2. Depending on the embodiment, additional blocks may be added, others removed, and the ordering of the blocks may be replaced.

In block S20, the electronic device 1 is enabled to monitor the baby in the crib 3. In response to enabling the electronic device 1, the camera 12 starts to capture an image of the baby in the crib 3.

In block S22, the image acquiring module 22 acquires the captured image of the baby from the camera 12 of the electronic device 1.

In block S24, the connection module 24 establishes a communication between the electronic device 1 and the communication device 5 using the communication module 13 and the network 4, and the transmission module 28 sends the captured image of the baby to the communication device 5 through the communication.

In block S26, the recognition module 26 determines if a face zone of the baby is detected from the captured image of the baby. A detailed recognition process is mentioned above.

If no face zone of the baby is detected from the captured image, the procedure goes to block S32 directly.

If the face zone of the baby is detected from the captured image, in block S28, the recognition module 26 locates an eye area in the face zone, and the analysis module 29 calculates a ratio (H/W) of a height (H) and a width (W) of the eye area. A detailed recognition process of the eye area is mentioned above.

In block S30, the analysis module 29 determines if the baby is awake by determining if the calculated ratio is greater than the threshold value. If the calculated ratio is not greater than the threshold value, the analysis module 29 determines that the baby is asleep, and then the procedure returns to block S22.

If the calculated ratio is not greater than the threshold value, in block S32, the analysis module 29 determines that the baby is awake, and the transmission module 28 sends the warning message to the communication device 5.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A method for monitoring a baby sleeping using an electronic device positioned on a crib, the electronic device comprising a camera and a communication module, the method comprising:
presetting a warning message to warn a user to look at the baby in the crib, and designating a communication device of the user to receive the warning message;
acquiring a captured image of the baby from the camera;
establishing a communication between the electronic device and the designated communication device using the communication module;
sending the captured image of the baby to the designated communication device through the communication;
determining if a face zone of the baby is detected from the captured image; and
sending the warning message to the designated communication device if no face zone of the baby is detected from the captured image.

2. The method according to claim 1, further comprising:
setting a warning icon; and
appending the warning icon on the captured image if no face zone of the baby is detected from the captured image.

3. The method according to claim 1, further comprising:
locating an eye area in the face zone if the face zone of the baby is detected from the captured image.

4. The method according to claim 3, further comprising:
setting a threshold value to determine if the baby is awake;
calculating a ratio of a height and a width of the eye area;
comparing the calculated ratio with the threshold value; and
determining that the baby is awake if the calculated ratio is greater than the threshold value, or determining that the baby is asleep if the calculated ratio is less than the threshold value.

5. The method according to claim 4, further comprising:
sending the warning message to the designated communication device under the condition that the baby is awake.

6. The method according to claim 4, further comprising:
setting a warning icon; and
appending the warning icon on the captured image under the condition that the baby is awake.

7. An electronic device, the electronic device being positioned on a crib, the electronic device comprising:
a camera;
a communication module;
a storage system;
at least one processor; and
one or more programs stored in the storage system and being executable by the at least one processor, the one or more programs comprising:
a setting module operable to preset a warning message to warn a user to look at a baby in the crib, and designate a communication device of the user to receive the warning message;
an image acquiring module operable to acquire a captured image of the baby from the camera;
a connection module operable to establish a communication between the electronic device and the designated communication device using the communication module;
a transmission module operable to send the captured image of the baby to the designated communication device through the communication;
a recognition module operable to determine if a face zone of the baby is detected from the captured image; and
the transmission module further operable to send the warning message to the designated communication device if no face zone of the baby is detected from the captured image.

8. The electronic device according to claim 7, wherein:
the setting module is further operable to set a warning icon; and
the transmission module is further operable to append the warning icon on the captured image if no face zone of the baby is detected from the captured image.

9. The electronic device according to claim 7, wherein the recognition module is further operable to locate an eye area in the face zone if the face zone of the baby is detected from the captured image.

10. The electronic device according to claim 7, wherein the one or more programs further comprise an analysis module:
the setting module is further operable to set a threshold value to determine if the baby is awake;
the analysis module is operable to calculate a ratio of a height and a width of the eye area, compare the calculated ratio with the threshold value, and determine that the baby is awake if the calculated ratio is greater than the threshold value, or determine that the baby is asleep if the calculated ratio is less than the threshold value.

11. The electronic device according to claim 10, wherein the transmission module is further operable to send the warning message to the designated communication device under the condition that the baby is awake.

12. The electronic device according to claim 10, wherein:
the setting module is further operable to set a warning icon; and
the transmission module is further operable to append the warning icon on the captured image under the condition that the baby is awake.

13. A storage medium storing a set of instructions, the set of instructions capable of being executed by a processor to perform a method for monitoring a baby sleeping using an electronic device positioned on a crib, the electronic device comprising a camera and a communication module, the method comprising:
presetting a warning message to warn a user to look at the baby in the crib, and designating a communication device of the user to receive the warning message;
acquiring a captured image of the baby from the camera;
establishing a communication between the electronic device and the designated communication device using the communication module;
sending the captured image of the baby to the designated communication device through the communication;
determining if a face zone of the baby is detected from the captured image; and
sending the warning message to the designated communication device if no face zone of the baby is detected from the captured image.

14. The storage medium as claimed in claim 13, wherein the method further comprises:
setting a warning icon; and
appending the warning icon on the captured image if no face zone of the baby is detected from the captured image.

15. The storage medium as claimed in claim 13, wherein the method further comprises:
locating an eye area in the face zone if the face zone of the baby is detected from the captured image.

16. The storage medium as claimed in claim 15, wherein the method further comprises:
setting a threshold value to determine if the baby is awake;
calculating a ratio of a height and a width of the eye area;
comparing the calculated ratio with the threshold value; and
determining that the baby is awake if the calculated ratio is greater than the threshold value, or determining that the baby is asleep if the calculated ratio is less than the threshold value.

17. The storage medium as claimed in claim 16, wherein the method further comprises:
sending the warning message to the designated communication device under the condition that the baby is awake.

18. The storage medium as claimed in claim 16, wherein the method further comprises:
setting a warning icon; and
appending the warning icon on the captured image under the condition that the baby is awake.
